(19) United States
(12) Patent Application Publication
(10) Pub. No.: US 2013/0127183 A1
(43) Pub. Date: May 23, 2013

(54) LOCKING DEVICE FOR TOOL BOXES

(71) Applicant: Fu-Shiong Chang, Taichung (TW)

(72) Inventor: Fu-Shiong Chang, Taichung (TW)

(21) Appl. No.: 13/300,653

(22) Filed: Nov. 20, 2011

(51) Int. Cl. E05C 3/14

(52) U.S. Cl. 292/202

(57) ABSTRACT

A locking device for a tool box and includes a body and a decoration plate. The body has a recess and a protrusion is located in the recess. The decoration plate is mounted to the recess to reinforce the body. The decoration plate has an opening through which the protrusion extends through and is exposed on the front side of the decoration plate. The protrusion has different color from that of the decoration plate to provide more distinguishable feature.

### FIELD OF THE INVENTION

The present invention relates to a locking device, and more particularly, to a locking device for tool boxes so as to improve aesthetic appearance and strength.

### BACKGROUND OF THE INVENTION

A conventional tool box is disclosed in U.S. Pat. No. 6,082,539 and generally includes a body, a cover and a locking unit which is pivotably connected to the body. The body has positioning portion and holes so that the pivots of the locking unit are pivotably engaged with the holes. The locking units have engaging portions which are engaged with the positioning portions on the cover, or the positioning s on the base. The locking units have two lugs and each lug can be folded or pivoted to perform locking action in two stages. However, the lugs are made by way of plastic injection molding and each of the two parts of each lug has only one color. Therefore, if the two parts of each lug have different colors, multiple-color injection molding machine is needed which increases the manufacturing cost. There is an arrow head on the lugs so as to instruct the direction that users are to operate the locking device. The single-colored lug cannot make the arrow head to be more distinguishable.

The present invention intends to provide a locking device for tool boxes to improve aesthetic appearance and strength.

### SUMMARY OF THE INVENTION

The present invention relates to a locking device for a tool box and comprises a body and a decoration plate. The body has a recess and a protrusion is located in the recess. The decoration plate is mounted to the recess to reinforce the body. The decoration plate has an opening through which the protrusion extends through and is exposed on the front side of the decoration plate. The protrusion has different color from that of the decoration plate to provide more distinguishable feature.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the locking device of the present invention;

FIG. 2 is a perspective view to show the locking device of the present invention;

FIG. 3 is a front view of the locking device of the present invention;

FIG. 4 is a cross sectional view, taken along line A-A of FIG. 3;

FIG. 5 is a cross sectional view, taken along line B-B of FIG. 3;

FIG. 6 is an exploded view to show the locking device of the present invention and a tool box;

FIG. 7 shows the front end view of the second embodiment of the shaft of the locking device of the present invention;

FIG. 8 shows the rear end view of the second embodiment of the shaft of the locking device of the present invention;

FIG. 9 shows another embodiment of the decoration plate of the present invention, and

FIG. 10 shows yet another embodiment of the decoration plate of the present invention.

### DETAILED DESCRIPTION OF THE PREFERRED EMBODIMENT

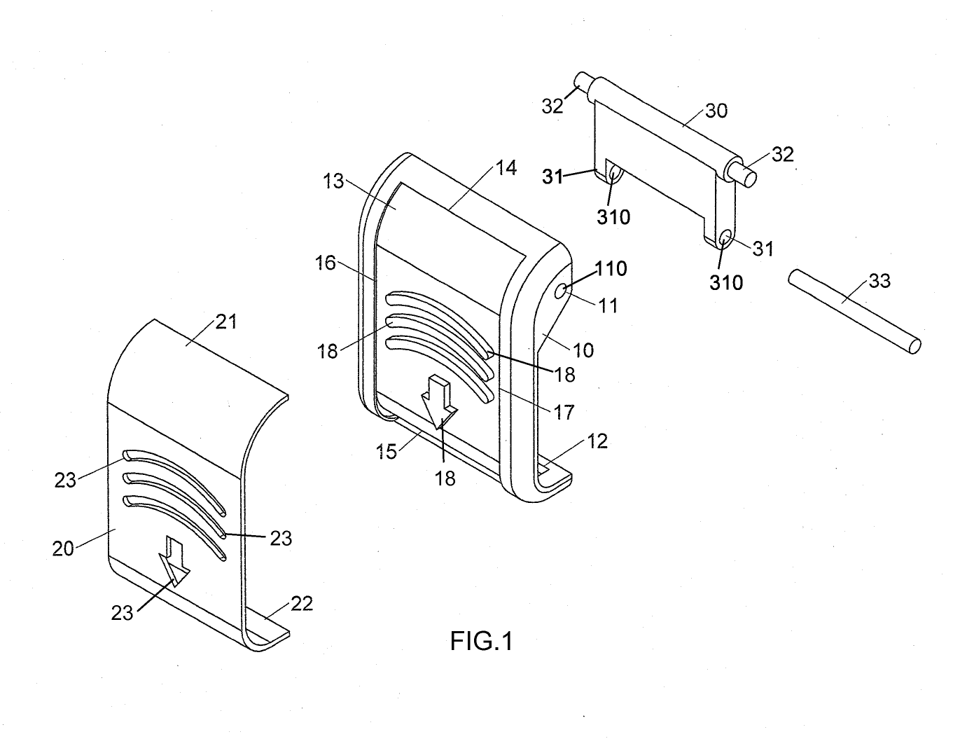

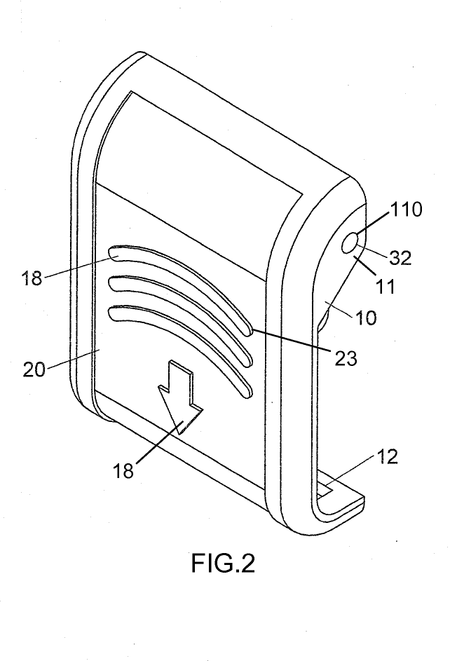

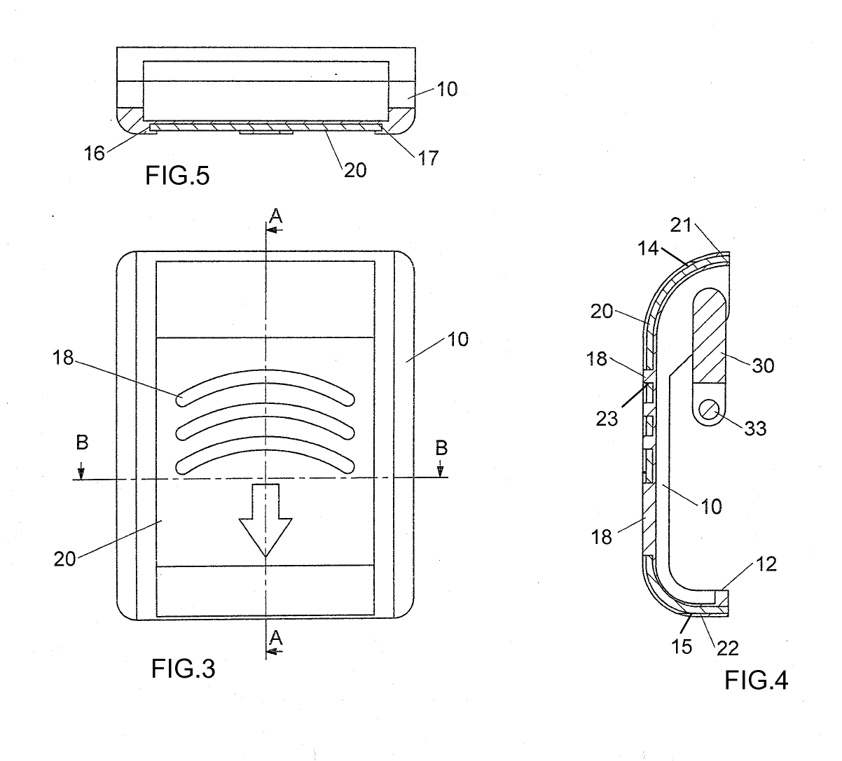

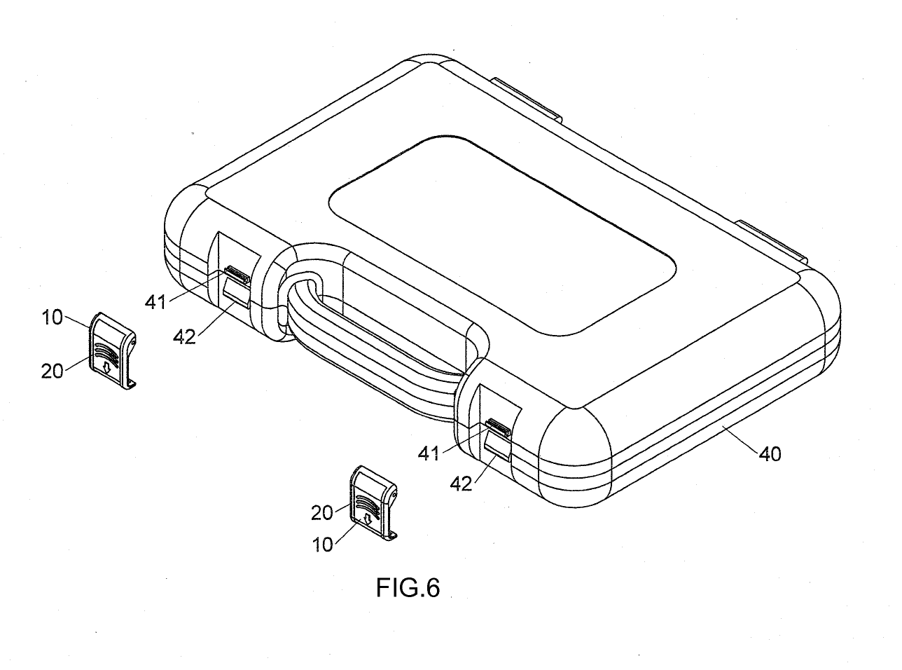

Referring to FIGS. 1 to 6, the locking device for a tool box of the present invention comprises a body 10 and a decoration plate 20, wherein the body 10 is made by way of plastic injection molding to be a flat piece and has two first lugs 11 on two sides of the first end thereof. A shaft 33 extends through the first lugs 11 and is pivotably connected to a tool box. The body 10 has a locking portion 12 on the second end thereof and the locking portion 12 is a hook so as to be engaged with the tool box. The body 10 has a recess 13 defined in the front side thereof and two ends of the recess 13 each have a first engaging slot 14 and a second engaging slot 15. The first engaging slot 14 and the first lug 11 are located on the same end of the body 10, and the second slot 15 and the locking portion 12 are located on the same end of the body 10. The recess 13 has a third engaging slot 16 and a fourth engaging slot 17 respectively located on two sides thereof. The recess 13 has at least one protrusion 18 located therein, in the drawing, there are multiple protrusions 18 which are in a form of elongate protrusions and each protrusion 18 has its longitudinal axis extending along the width of the body 10. The distal end of the protrusion 18 is in flush with the surface of the front side of the body 10, or protrudes out from the surface of the front side of the body 10. The protrusion 18 is a pattern, an arrow head, a symbol or any pattern. The decoration plate 20 is made by iron, steel, aluminum or copper, and has proper strength. The decoration plate 20 is engaged with the recess 13 of the body 10. The decoration plate 20 has a first connection portion 21 and a second connection portion 22 respectively located on two ends thereof. The first connection portion 21 is engaged with the first engaging slot 14, and the second connection portion 22 is engaged with the second engaging slot 15. Two sides of the decoration plate 20 are respectively engaged with the third engaging slot 16 and the fourth engaging slot 17 so that the four sides of the decoration plate are connected evenly with the body 10. The front side of the decoration plate 20 and the front side of the body 10 are in flush with each other, or the front side of the decoration plate 20 is lower than the front side of the body 10. The decoration plate 20 has a first opening 23 through which the protrusion 18 extends and is exposed on the front side of the decoration plate 20. When in manufacturing, the decoration plate 20 is out in the molds of the body 10 and is molded together with the body 10, so that the decoration plate 20 is connected with the recess 13 of the body 10.

FIG. 1 shows the embodiment with the shaft 33 connected to the first lugs 11 and a board 30 is cooperated with the embodiment. The board 30 has two second lugs 31 respectively extending from two sides of the first end thereof, and two pivots 32 extend from two sides of the second end of the board 30. Each second lug 31 has a first through hole 310 and two ends of the shaft 33 are fixed to the two first through holes 310. The mediate section of the shaft 33 is located between the two second lugs 31.

As shown in FIG. 6, the tool box 40 has two engaging blocks 41 and two hooking portions 42, the engaging blocks 41 are connected with the shaft 33 and the hooking portions 42 are connected with the locking portions 12 of the body 10.

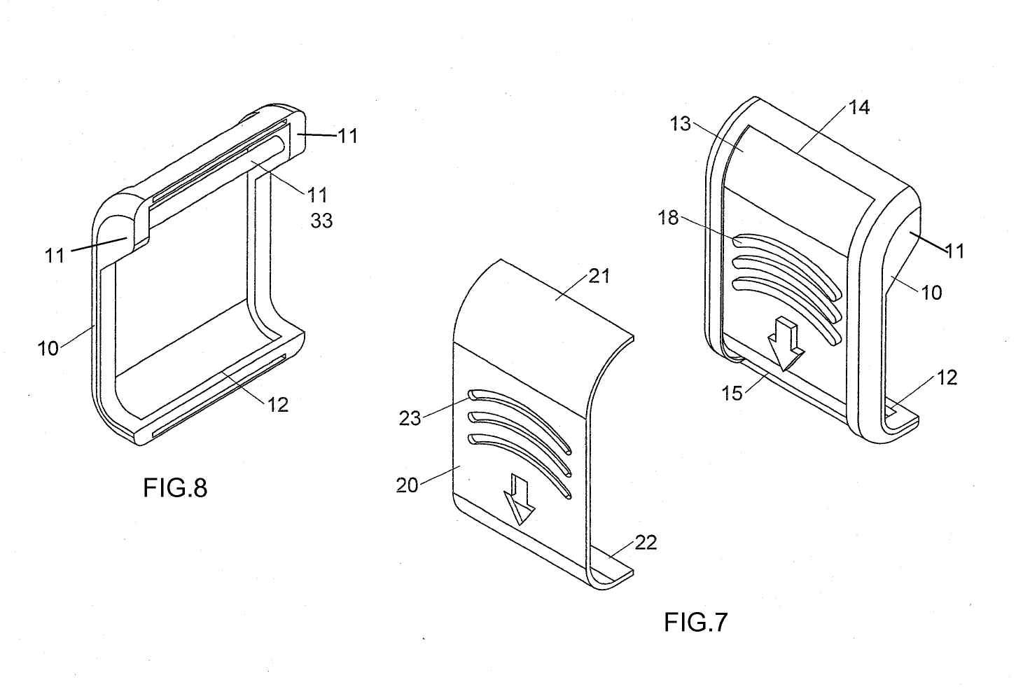

FIGS. 7 and 8 show that the two first lugs 11 of the body 10 each have a second through hole 110 and two ends of the shaft 33 are fixed to the two second through holes 110. The mediate section of the shaft 33 is located between the two first lugs 11.

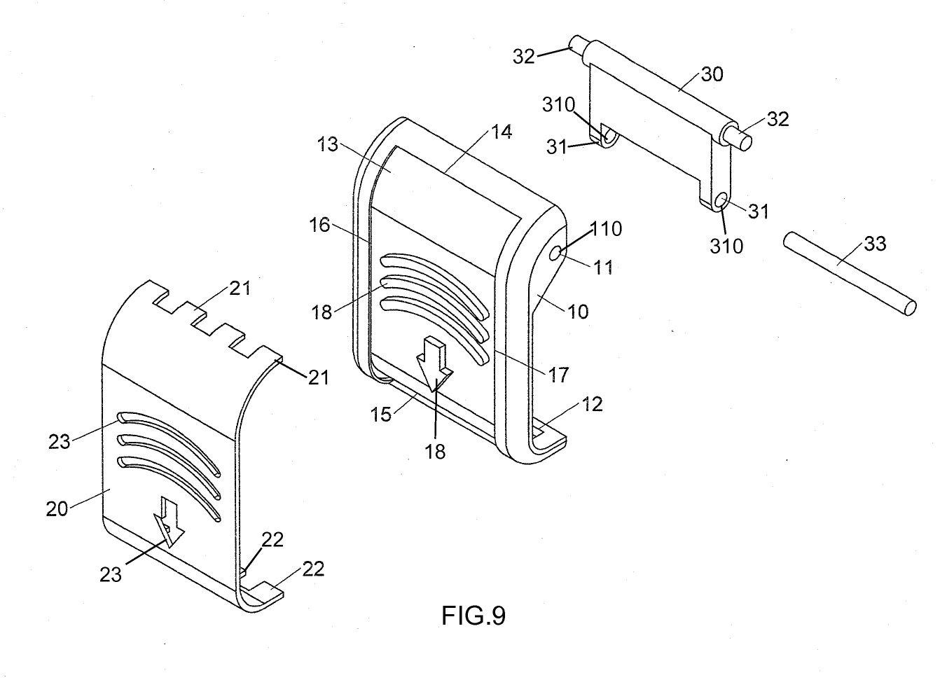

FIG. 9 shows that there are multiple first engaging slots 14 and multiple second engaging slots 15. There are multiple first and second connection portions 21, 22 of the decoration plates 20 so as to be cooperated with the first engaging slots 14 and the second engaging slots 15.

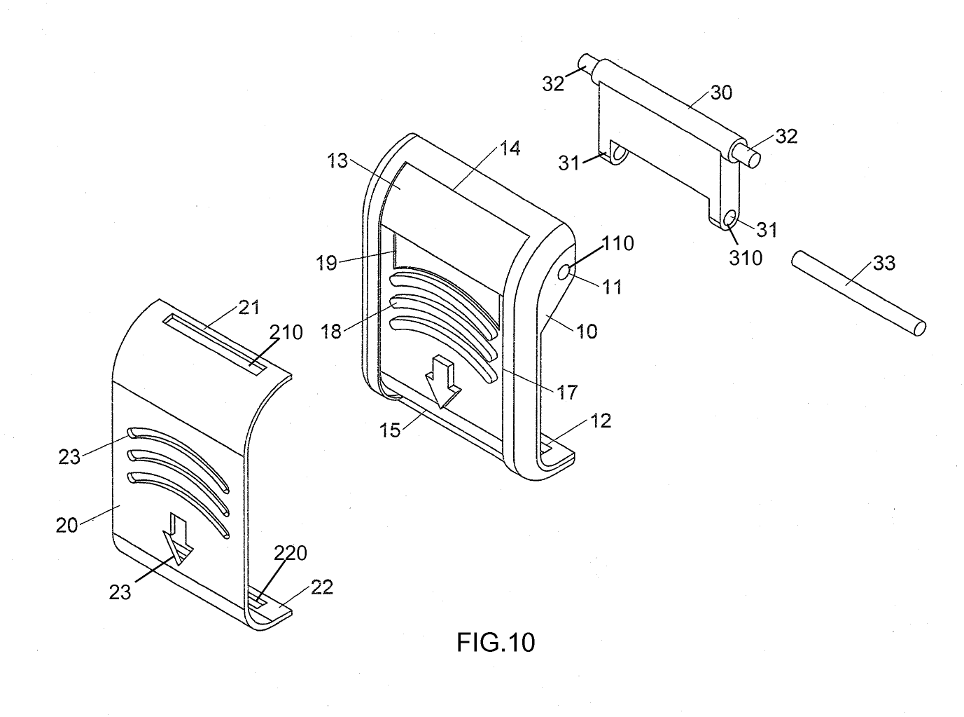

FIG. 10 shows that the first engaging slots 14 and the second engaging slots 15 are C-shaped and the first and second connection portions 21, 22 of the decoration plates 20 are C-shaped so as to be cooperated with the C-shaped first engaging slots 14 and the second engaging slots 15. The body 10 has a second opening 19 so as to reduce weight of the body 10.

The present invention has metal decoration plates 20 connected to the body 10 so that the strength of the body 10 is improved and the body 10 is not easily damaged when dropping on the ground. The decoration plates 20 are connected to recesses in the four sides of the body 10 so that the decoration plates 20 are secured to the body 10. The protrusions 18 are exposed from the decoration plates 20 and the color of the body 10 is different from that of the decoration plate 20 so that the protrusions 18 are surround by the decoration plates 20 of different color to improve the aesthetic appearance and the protrusions 18 are more distinguishable.

While we have shown and described the embodiment in accordance with the present invention, it should be clear to those skilled in the art that further embodiments may be made without departing from the scope of the present invention.

What is claimed is:

1. A locking device comprising:
a body having two first lugs on two sides of a first end thereof, a shaft extending through the first lugs and adapted to be pivotably connected to a tool box, the body having a locking portion on a second end thereof and the locking portion adapted to be engaged with the tool box, the body having a recess defined in a front side thereof and two ends of the recess each having at least one first engaging slot and at least one second engaging slot, the at least one first engaging slot and the first lug located on the same end of the body, the at least one second slot and the locking portion located on the same end of the body, the recess having a third engaging slot and a fourth engaging slot respectively located on two sides thereof, the recess having at least one protrusion located therein, and
a decoration plate made by metal and engaged with the recess of the body, the decoration plate having at least one first connection portion and at least one second connection portion respectively located on two ends thereof, the at least one first connection portion engaged with the at least one first engaging slot, the at least one second connection portion engaged with the at least one second engaging slot, two sides of the decoration plate respectively engaged with the third engaging slot and the fourth engaging slot, the decoration plate having a first opening through which the at least one protrusion extends and being exposed on a front side of the decoration plate.

2. The locking device as claimed in claim 1, wherein a distal end of the at least one protrusion is in flush with a surface of the front side of the body, or protrudes out from the surface of the front side of the body.

3. The locking device as claimed in claim 1, wherein the at least one protrusion is a pattern, an arrow head, or a symbol.

4. The locking device as claimed in claim 1, wherein there are multiple protrusions which are in a form of elongate protrusions and each protrusion has its longitudinal axis extending along a width of the body.

5. The locking device as claimed in claim 1, wherein the decoration plate is made by iron, steel, aluminum or copper.

6. The locking device as claimed in claim 1, wherein the front side of the decoration plate and the front side of the body are in flush with each other.

7. The locking device as claimed in claim 1, wherein the front side of the decoration plate is lower than the front side of the body.

8. The locking device as claimed in claim 1 further comprising a board and two second lugs respectively extending from two sides of a first end thereof, two pivots extending from two sides of a second end of the board, each second lug having a first through hole and two ends of the shaft fixed to the two first through holes, a mediate section of the shaft located between the two second lugs.

9. The locking device as claimed in claim 1, the two first lugs of the body each have a second through hole, two ends of the shaft are fixed to the two second through holes, a mediate section of the shaft located between the two first lugs.

10. The locking device as claimed in claim 1, wherein a distal end of the at least one protrusion is in flush with a surface of the front side of the body.

11. The locking device as claimed in claim 1, wherein a distal end of the at least one protrusion protrudes out from a surface of the front side of the body.

12. The locking device as claimed in claim 1, wherein there are multiple first connection portion and multiple second connection portions, there are multiple first engaging slots and multiple second engaging slots.

13. The locking device as claimed in claim 1, wherein the body has a second opening so as to reduce weight of the body.
